(19) United States
(12) Patent Application Publication
(10) Pub. No.: US 2003/0217551 A1
(43) Pub. Date: Nov. 27, 2003

(54) Solar chimney wind turbine

(76) Inventor: Ernest R. Drucker, North York (CA)

Correspondence Address: ARNE I. FORS, GOWLING, STRATHY & HENDERSON, SUITE 4900, COMMERCE COURT WEST, TRONTO, ON, M5L 1J3, CA

(21) Appl. No.: 10/341,559

(22) Filed: Dec. 13, 2002

Related U.S. Application Data
(63) Continuation of application No. PCT/CA01/00885, filed on Jun. 13, 2001.
(60) Provisional application No. 60/211,377, filed on Jun. 14, 2000.

(51) Int. Cl. F03G 7/00; F03G 6/00; B60L 8/00; B60K 16/00

(52) U.S. Cl. 60/641.12; 60/641.8

(57) ABSTRACT

A solar energy powerplant comprises at least one vertical tower with an open top mounted on a base structure. Each tower (10) has a height of at least 100 metres with a plurality of outwardly projecting heating chambers (12) mounted externally around the lower end of the vertical tower. Each heating chamber is a generally hollow chamber with walls formed of thin metal sheeting for absorbing solar energy, a closeable opening in a lower region of the chamber for introducing ambient air into the chamber and a closeable opening in an upper region of the chamber for releasing heated air accumulated in the chamber into the tower. A constricted zone, e.g. Venturi chamber, within the tower above the heated air inlet openings is adapted to increase the velocity of the heated air moving up the tower, and a wind powered turbine (14) is mounted within the constricted zone and adapted to drive an electrical generating unit. The height of each tower and the number and size of the heating chambers connected thereto are sufficient to provide a substantially continuous updraft in the tower for driving the turbine.

### TECHNICAL FIELD

This invention relates to a system for producing electrical energy, particularly with the use of solar heat as the prime energy source.

### BACKGROUND ART

The patent literature is replete with systems utilizing wind, waves, and solar heat as energy sources for generating electrical power. The main sources of electrical power in the world today are hydroelectric systems and fossil fuel powered generating systems. The next most significant source of electrical power is nuclear powered generators.

As far as hydroelectric power is concerned, the power generators must be reasonably close to their ultimate market and the heavily populated and industrialized sections of the world are fast using up all available new sources of hydropower. The systems powered by fossil fuels such as coal, gas and oil have the problem that these fuels are now becoming in short supply and also are becoming extremely expensive. Also, fossil fuels are environmentally objectionable, since these contribute to global warming and also contaminate the atmosphere by leaving poisonous residues not only in the air, but also often in many effluents. The nuclear systems are not only very expensive in terms of construction costs but they also have the problem of requiring extensive safety systems to protect against the radiation in the plant itself. Moreover, there is also the major problem of safely disposing of the highly dangerous wastes.

Because of these problems with the traditional systems, there has been a greatly increased interest in solar energy as a major energy source. Various systems have been proposed involving the use of solar energy for generating electrical power and some such systems have recently been developed for space vehicles see, for instance, Canadian Patent No. 718,175 issued Sep. 21, 1965. That system uses a solar energy absorber for heating a liquid which vaporizes to drive a turbine which in turn drives a generator. Such a system with its vaporizing and condensing systems is obviously practical only for very small systems such as would be used in space crafts.

There are many patents in existence which describe the use of wind power for driving electrical generators and one form of wind turbine generator is that described in U.S. Pat. No. 3,720,840 issued Mar. 14, 1973. In Goodman, U.S. Pat. No. 3,048,066, a vertical stack arrangement is described having a series of fans driven by solar created thermal currents, with the fans being capable of driving electric generators.

The failure of ground level solar energy collectors in the past has been related to an inadequate collection area. Thus, it is known that for a sunny region such as Texas, an average heat absorption of an optimally tilted collector is about 0.45 kw/m² as a year round average sunny, daylight hours. On this basis it has been estimated that a collector area of 37 square miles would be required for a 1000 mw powerplant.

Of course, it is highly desirable to have these plants close to major population areas and in these areas land is at a premium. One design of solar powerplant capable of greatly decreasing the land area requirements for a given amount of power production is that described in Drucker, U.S. Pat. No. 3,979,597, issued Sep. 7, 1976. Further improvements to that solar powerplant are described in Drucker, U.S. Pat. No. 5,694,774 and WO 99/47809.

In recent years there has been a growing interest in the solar chimneys. It consists of a very tall chimney, e.g. as high as 1000 metres with a hot air collector at the base. Turbines are mounted within the chimney in a lower region. A chimney of this type that is very tall relative to its diameter produces the highest upward velocities, with rising warm air within the chimney achieving speeds of 110 kph or more. Systems of this type have been constructed, but have encountered difficulties with both efficiency and durability.

A wind or water operated powerplant is described in Cohen, U.S. Pat. No. 4,079,264, which includes a Venturi passage. A rotary power device, e.g. a turbine, is mounted within the throat of the Venturi.

It is an object of the present invention to provide an improved form of solar energy powerplant having as a principal component one or more tall vertical towers.

It is a further object of the invention to advantageously use the tall vertical tower powerplant in combination with a Venturi passage.

### DISCLOSURE OF THE INVENTION

In accordance with the present invention there is provided a solar energy powerplant for producing electrical energy having as a principal component one or more tall vertical towers. Each tower is mounted on a base structure and is open at the top to permit an updraft. Wind powered turbines are mounted in the tower such that chimney updrafts in the tower drives the turbines. The turbines in turn drive electrical generators.

A large heat input is required in order to generate the heat necessary for the updrafts to drive the turbines. In accordance with this invention, a plurality of radially spaced, outwardly projecting heating chambers are mounted externally around the base of each tower. Each of these heating chambers is a generally hollow chamber with walls formed of thin metal sheeting for absorbing solar energy. A closeable inlet opening is provided for introducing ambient air into the chamber and a closeable outlet opening is provided for releasing heated air accumulated in the chamber into the tower.

Typically at least 20 heating chambers surround a tower and the inlet and outlet closures in each of these chambers may be adjustable whereby the closures remain closed while ambient air trapped within the chambers is heated to a predetermined temperature, at which time both closures open to transfer heated air to the tower and replace it with ambient air. In this manner the heating chambers can be sequentially opened and closed individually or in groups whereby a continuous strong updraft is maintained.

A constricted zone is provided within the tower directly above the heated air inlets, this comprising a Venturi chamber adapted to increase the velocity of the heated air moving up the tower. A turbine is mounted within the throat of the Venturi chamber at a point of maximum air velocity. The Venturi chamber serves to at least triple the speed of the rising air stream driving the turbine. The height of each tower and the number and size of the heating chambers connected thereto are sufficient to provide a substantially continuous updraft in the tower for driving the turbine.

It has been found that for maximum efficiency, it is important to maintain a low moisture level in the updraft air. Otherwise, condensation takes place within the tower, which not only interferes with the updraft but also causes corrosion. Accordingly, where required, the inlet air is passed through a dehumidifier prior to entering the tower. The air should enter the tower at a moisture level of less than about 10% and preferably less than about 5%.

Dehumidifiers may conveniently be located in upper regions of the heating chambers and/or within the Venturi chamber below the turbine.

Each tower is preferably circular in cross-section and each Venturi chamber is preferably in the form of an inwardly tapered frusto-conical inlet portion, a central throat portion of square or rectangular cross-section and an outwardly tapered frusto-conical outlet portion. The wind powered turbine is mounted within the central throat portion on either a horizontal or vertical axis. The turbine drives a generator for generating electrical energy.

While the powerplant of this invention is intended to be powered primarily by solar energy, the heat requirements within the heating chambers may be supplemented by additional heaters. For instance, in situations where a powerplant according to the invention is intended to provide electrical power 24 hours a day, sunlight is the power source during day light hours and gas burners may be provided in the heating chambers for heating during hours without sunlight. This remains an efficient system since only a small increase in temperature of the ambient air is required to create the necessary updraft in the tall towers. Typically a temperature differential of 7-8° C. is sufficient to provide the necessary updraft.

In desert regions, another source of night heat is to provide a layer of asphalt in the bottom of each heating chamber. This asphalt absorbs large quantities of heat during the very hot desert day and slowly releases the heat to the air passing through the chamber at night.

It is also advantageous according to this invention to locate the towers in regions having strong prevailing winds. Thus, the greater is the speed of the wind blowing across the top of the towers the greater is the air updraft within the towers.

According to a further feature of this invention, the surfaces on the tower exposed to the rays of the sun provide excellent locations for photovoltaic cells. The photovoltaic cells are used for direct production of additional electricity during sunlight hours.

### BEST MODES FOR CARRYING OUT THE INVENTION

The tower is tall relative to its diameter, e.g. a ratio of height:diameter of at least 10:1, since this produces the highest upward air velocities. A commercial tower may have a height of 400 metres or more and a diameter of as much as 30 metres. Rising warm air within such a tower can achieve speeds of up to 110 kph. In one preferred embodiment, a tower 30 metres in diameter has a Venturi chamber with a throat portion having an area of about 144 m². Typically, a tower comprises a concrete lower portion extending upwardly less than about 25% of the total height of the tower. For the above commercial tower, the concrete base portion has a height of about 30 metres. Above this concrete base portion is mounted an insulated steel tower.

The heating chambers are also large and an individual chamber may have a volume of as much as 4000 m³. This means that a tower with 20 such heating chambers has a total air heating volume of 80000 m³.

It is preferred to operate the heating chambers in pairs. In this way, with the above arrangement 2×4000 m³=8000 m³ of heated air is sequentially released to the Venturi chamber every 2 minutes. The temperature differential is typically about 7° C. It is also possible to feed additional outside air directly into the Venturi chamber thereby increasing the air flow by as much as 40%. When this is done, the temperature differential for the air passing through the Venturi chamber is about 5° C.

In night time operation, the temperature differential is about 18° C. without additional air feeding directly into the tower, while with an additional 40% air being fed in, the temperature differential is about 12° C.

The powerplant is provided with automatic controls which regulate the air flow travelling up the tower. This is conveniently done by measuring the turbine speed within the tower and utilizing this to control dampers on air inlets to the solar heating chambers and the inlets from the heating chambers to the tower. For instance, during periods of peak solar radiation, there is sufficient solar energy to provide a maximum updraft in the tower. On the other hand, during periods of minimum solar radiation, the auxiliary heaters in the heating chambers are used. In this way, a relatively constant upward air flow through the tower is maintained.

It is also necessary to monitor the moisture content of the air within the tower and make the necessary adjustments to maintain the moisture level below a maximum permitted amount which is less than 10%.

### BRIEF DESCRIPTION OF THE DRAWINGS

The invention is further illustrated by the attached drawings, in which:

FIG. 1 is a schematic elevation view of a tower according to the invention;

FIG. 2 is an elation view of a constructed zone;

FIG. 3 is a partial top plan view showing an arrangement of heating chambers;

FIG. 4 is a perspective view of a heating chamber base;

FIG. 5 is a perspective view of a heating chamber; and

FIG. 6 is a sectional view of the heating chamber of FIG. 4 and the tower.

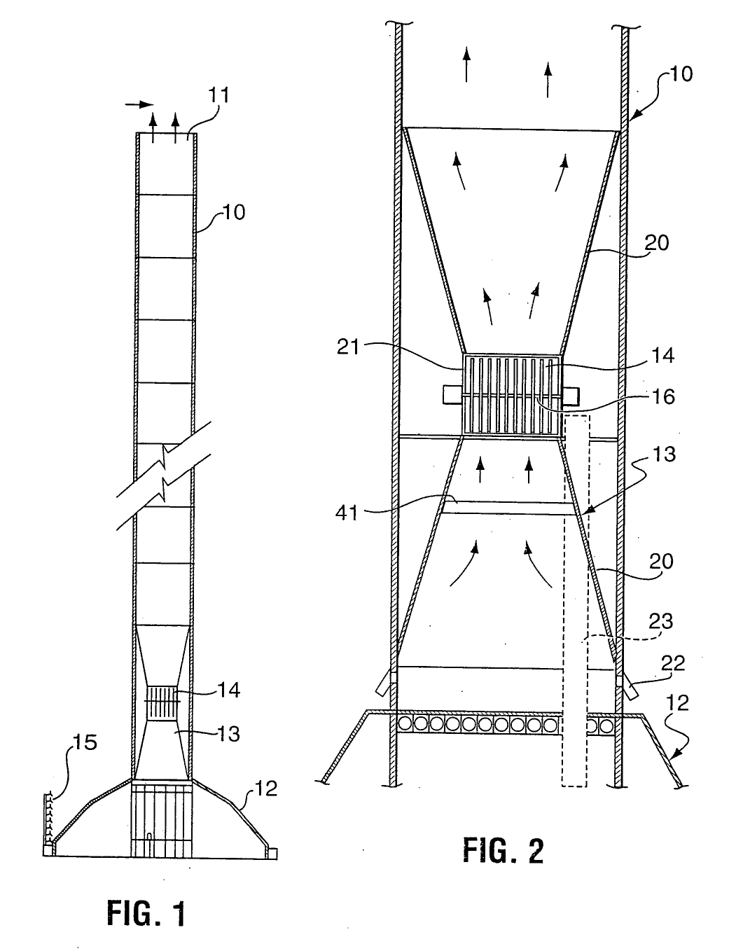

The general appearance of the powerplant of this invention can be seen from FIG. 1. Thus, it comprises a tall slender tower 10 having an open top 11 and surrounded at the bottom by a series of radially projecting heating chambers 12. Directly above the heating chambers 12 within the tower 10 is a Venturi chamber 13 containing a turbine 14. Moveable reflectors 15 may be used to concentrate the rays of the sun onto the heating chambers 12.

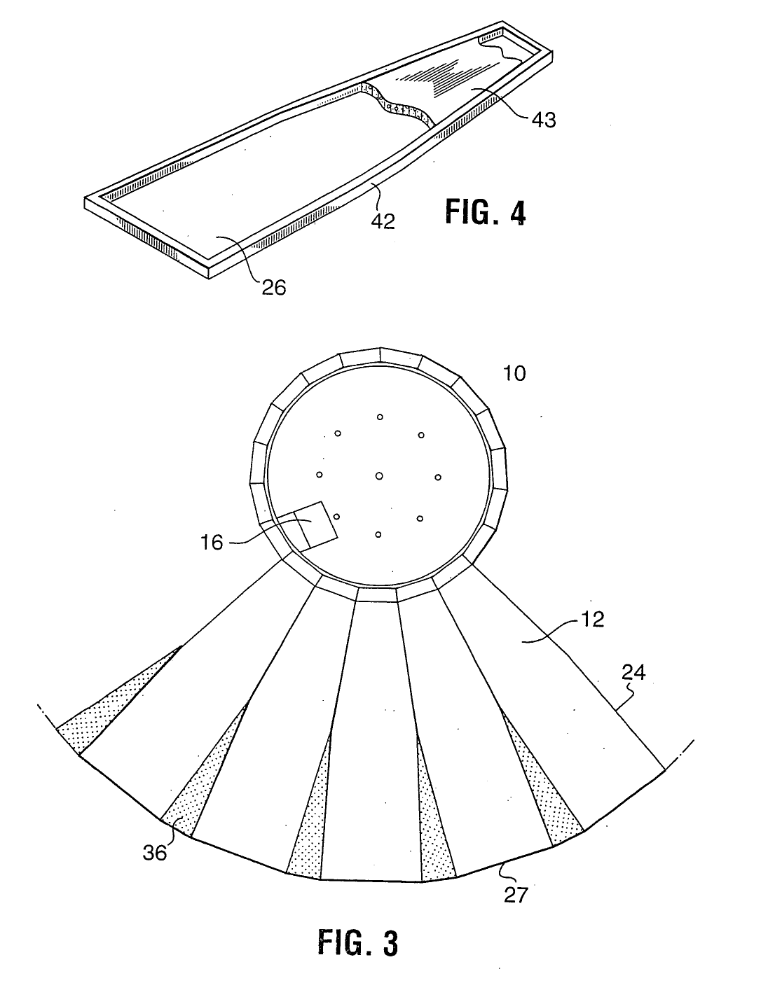

The design of a preferred form of heating chamber can be seen from FIGS. 3 to 6.

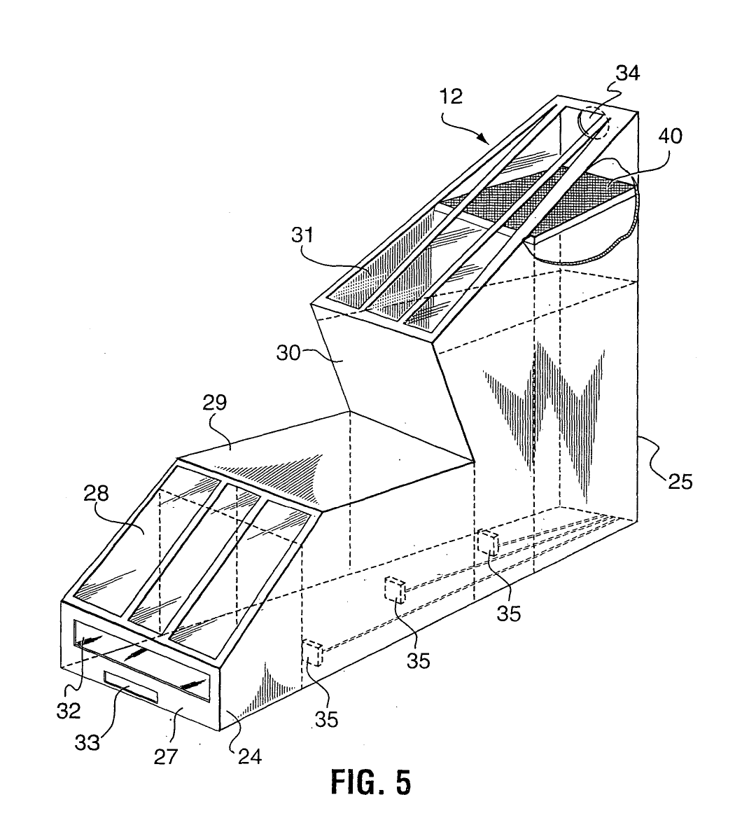

FIG. 3 is a partial top plan view showing how the heating chambers 12 are arranged relative to the tower 10. As seen in FIG. 5, each heating chamber 12 is preferably formed of light gauge, black painted sheet metal and glass panels. Thus, each chamber includes sheet metal sidewall panels 24, inner end wall 25, outer end wall 27 and intermediate panels 29 and 30 and a concrete base 26. The outer end wall 27 includes a glass panel 32 for auxiliary radiant input and also includes a closeable ambient air inlet 33. A sloping wall is provided between outer wall 27 and intermediate panel 29. This sloping wall includes glass panels 28 to again permit the penetration of sun rays. Panels 29 and 30 are black coloured to absorb heat and a further sloping face is provided between the top of panel 30 and the top of inner wall 25. This sloping panel also includes further glass panels 31 to permit entry of sun rays. An outlet opening 34 is located at the top of inner wall 25 and this comprises a closeable opening for feeding heated air from the heating chamber 12 into the tower 10. Auxiliary heaters 35 may also be provided for heating the chambers where there is insufficient sun. These heaters 35 are preferably burners fueled by gas.

As further seen from FIG. 5, the walls of each heating chamber 12 provide a wedge-shaped gap 36 between the heating chambers and this serves to provide more wall panel surface area for solar heating.

The air inlet 33 to each chamber 12 and the air outlet 34 are controlled by adjustable closures (not shown), preferably operated by electric motors. These adjustable closures are of known type and may be selectively adjusted to any point between fully open and fully closed in response to computer signals.

Further air inlets 22 are located at the base of the Venturi chamber 13 and these connect directly to the outside. Flow through these inlets is controlled by adjustable closures (not shown) and preferably operated by electric motors. Depending upon atmospheric conditions, these inlets 22 can be opened to bleed as much as an additional 40% air into the stream of heated air emerging from the heating chambers.

A preferred form of base 26 for a heating chamber is shown in FIG. 4. It includes lower sidewalls 42 on base 26 with the volume within the walls 42 being filled with asphalt 43. This is particularly advantageous in desert regions where ambient temperatures may range from a high of 45° C. or more to night temperatures as low as 8-12° C. During the day the asphalt absorbs heat to the point of being liquified. During the night this very hot asphalt gradually cools, giving up its heat to the air passing through the heating chamber.

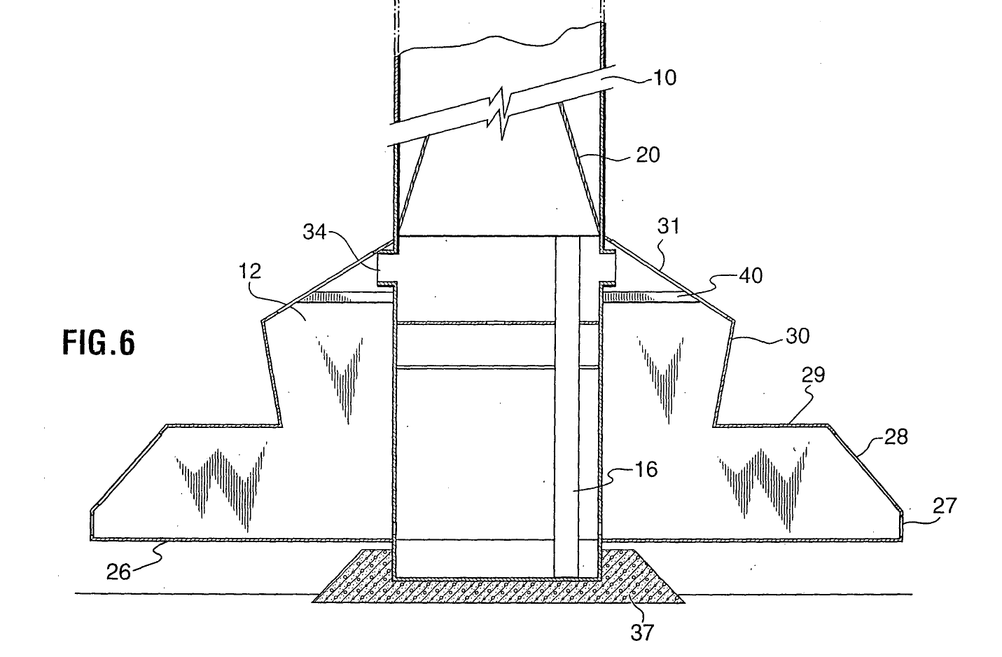

FIG. 6 further shows the arrangement of the heating chambers 12 relative to the base of the tower 10. The bottom of the tower 10 is preferably supported on a heavy concrete foundation 37 and the walls of the tower to the Venturi chamber 20 are preferably formed of reinforced concrete. The remainder of the tower is formed of metal, e.g. corrugated galvanized steel. FIG. 6 more clearly shows the heated air outlets 34 from the heating chamber 12 into the tower 10 beneath the Venturi chamber 20.

Greater details of the Venturi chamber can be seen in FIG. 2. Thus, it includes tapered frusto-conical portions 20 merging with a square throat portion 21 within which is mounted a turbine 14 on a horizontal shaft 16. This powers an electric generator (not shown). Additional air may be fed into the tower through auxiliary air inlets 22. An elevator shaft 23 is provided for servicing the turbine 14.

A dehumidifier 40 is mounted in an upper region of each heating chamber 12 as shown in FIG. 5. A further dehumidifier is also positioned within the inlet side of the Venturi chamber 13 as shown in FIG. 2.

For optimum operating efficiency, each powerplant tower is controlled by a computer system. The following information is monitored and fed back to a computer.

(i) Temperature and moisture content of air entering each heating chamber;

(ii) Temperature and moisture content of air exiting each heating chamber and into tower;

(iii) Air flow through each heating chamber;

(iv) Air temperature inside and outside tower at about 8 metre intervals of the height of the tower;

(v) Air speed inside the tower at about 8 metre intervals;

(vi) Turbine speed (rpm)—about every 2 minutes;

(vii) Air speed of air exiting top of tower (about every 2 minutes);

(viii) Atmospheric wind velocity at top of tower; and

(ix) Quantity of electricity being generated.

Based on this information, the computer is programmed to open and close the air inlet and outlet for each heating chamber, control the moisture content of the air passing up the tower, etc.

1. A solar energy powerplant comprising at least one vertical tower with an open top mounted on a base structure,
each said tower having a height of at least 100 metres with a plurality of outwardly projecting heating chambers mounted externally around the lower end of the vertical tower, each said heating chamber being a generally hollow chamber with walls formed of thin metal sheeting for absorbing solar energy, a closeable opening in a lower region of each said chamber for introducing ambient air into the chamber and a closeable opening in an upper region of each said chamber for releasing heated air accumulated in the chamber into the tower, a constricted zone within the tower above the heated air inlet openings adapted to increase the velocity of the heated air moving up the tower, and a wind powered turbine mounted within said constricted zone and adapted to drive an electrical generating unit, and
the height of each tower and the number and size of the heating chambers connected thereto being sufficient to provide a substantially continuous updraft in the tower for driving the turbine.

2. A solar energy powerplant according to claim 1 wherein the tower is circular in cross-section.

3. A solar energy powerplant according to claim 2 wherein the tower includes a lower concrete portion adjacent the heating chambers and an upper insulated sheet metal portion.

4. A solar energy powerplant according to claim 1, 2 or 3 which includes mobile reflectors for directing sunlight onto the heating chambers.

5. A solar energy powerplant according to any one of claims 1-4 which includes auxiliary gas-fueled burners within the heating chambers.

6. A solar energy powerplant according to claim 2 wherein the constricted zone comprises a Venturi chamber having an inwardly tapered frusto-conical inlet portion, a central portion of square or rectangular cross-section and an outwardly tapered frusto-conical outlet portion.

7. A solar energy powerplant according to claim 6 wherein the wind powered turbine is mounted on a horizontal axis within the central portion of the Venturi chamber.

8. A solar energy powerplant according to any one of claims 1-7 which includes a dehumidifier for removing moisture from the ambient air entering the Venturi chamber.

9. A solar energy powerplant according to claim 8 wherein the dehumidifier is adapted to reduce the moisture of the air to less than 10%.

10. A solar energy powerplant according to claim 9 wherein dehumidifiers are located in an upper region of each heating chamber below the heated air outlet.

11. A solar energy powerplant according to claim 9 or 10 which also includes a dehumidifier located within the inlet portion of the Venturi chamber.

12. A solar energy powerplant according to any one of claims 1-11 which includes additional closeable air inlets for feeding outside air directly into tower below the Venturi chamber.
